(19) United States
(12) Patent Application Publication
(10) Pub. No.: US 2023/0374965 A1
(43) Pub. Date: Nov. 23, 2023

(54) ROTATING WAVE ENERGY ABSORBER

(71) Applicant: MARINE POWER SYSTEMS LIMITED, Swansea South Wales (GB)

(72) Inventor: Graham FOSTER, Swansea South Wales (GB)

(73) Assignee: MARINE POWER SYSTEMS LIMITED, Swansea South Wales (GB)

(21) Appl. No.: 18/362,241

(22) Filed: Jul. 31, 2023

Related U.S. Application Data
(63) Continuation of application No. PCT/GB2022/050273, filed on Feb. 2, 2022.

(30) Foreign Application Priority Data
Feb. 2, 2021 (GB) 2101430.3

(51) Int. Cl. F03B 13/18

(52) U.S. Cl. CPC F03B 13/1825; F05B 2240/97; F05B 2250/42; F05B 2250/73

(57) ABSTRACT

A wave energy absorber is provided for use with a wave energy converter, the absorber having one or more body portions arranged to engage hydrodynamically with a water flow from waves of a body of water, the one or more body portions having a rotational axis about which the one or more body portions are arranged to rotate. The one or more body portions are asymmetrical about the rotational axis. The present invention aims to provide an improved energy capturing member for use with the wave energy converter which allows a pressure difference to be created by the wave energy absorber that is ultimately converted into useful energy, done using a smaller and lighter structure.

### CROSS REFERENCE TO RELATED APPLICATIONS

This continuation application claims priority benefit from International Application No. PCT/GB2022/050273 filed on Feb. 2, 2022, which claimed priority from Great Britain Application No. 2101430.3 filed Feb. 2, 2021, which are incorporated herein by reference in their entirety.

### FIELD OF THE INVENTION

The present invention relates to a rotating absorber for a wave energy converter (WEC) device.

### BACKGROUND OF THE INVENTION

The world is transitioning to renewable energy—this transition will require the exploitation of all forms or renewable energy to provide the planet with energy it needs. One potential renewable energy source is wave power—an abundant and consistent energy resource available in all of the world's large oceans and seas. For this reason, means to improve the efficiency and cost effectiveness of wave power capture are needed.

Some current wave energy converting (referred herein as “WEC”) devices utilise an orbiting wave energy absorber, for example those described in WO2013068748 and WO2019002864 that is typically substantially cylindrical or spherical in shape. This shape is chosen because it is axisymmetric along an axis perpendicular to the wave direction and therefore has an equal hydrodynamic response in every direction pertaining to the rotating direction of the water flow created by the waves. This approach is effective at capturing wave energy, however, it has the disadvantage that a large volume is contained or entrained by the spherical/cylindrical shape. The large internal volume will either lead to a correspondingly large mass if ambient water is contained/entrained or a high buoyancy if a large volume of air is contained inside the shape. In both of these cases, high mass or high buoyancy (or a combination of both), increase the forces and power flows that have to be managed by the energy conversion drive system, increasing its cost, complexity and susceptibility to damage.

The large volume and surface area of the spherical/cylindrical absorber, due to its axisymmetric shape relative to the wave direction, does not have the ability to have a ‘parked’ or similar configuration where the area/volume presented to the waves is reduced to improved survival in large waves. (the entire absorber may be submerged to a greater depth in the water as described in WO2019002864 to reduce the force on the absorber, but this reduction in force is a result of less wave energy at greater depth, not a result of the hydrodynamic properties of the absorber.

It is therefore desirable to provide an absorber for a wave energy converting device which maximises wave energy capture without containing or entraining a large internal volume while being smaller, lighter, and less susceptible to storm-related damage.

### SUMMARY OF THE INVENTION

The present invention is directed to a wave energy absorber arranged to be submerged in a body of water in order to capture wave energy as part of wave energy capturing (WEC) device.

Asymmetrical shapes (with respect to the wave direction) have not been historically used for subsurface wave energy absorbers that follow an orbital trajectory because the water flow direction moves through 360 degrees as the waves move past the absorber, and the absorber is required to perform equally well from all directions to harness energy efficiently throughout the wave cycle. This is why cylinders (aligned to the wave direction) or spheres have typically been selected in the past for absorbers that follow an orbital pathway when harnessing wave energy.

The absorber disclosed in present invention is arranged to change a rotation-state thereof in accordance with a cyclic water flow direction caused by waves, in order to increase or reduce hydrodynamic forces acting thereon as a result of the water flow. In particular the present invention is directed to a wave energy absorber which is rotationally asymmetric about a rotational axis thereof, such that rotation of the absorber about the axis can align the absorber to a desired orientation relative to the water flow.

The absorber may be able to maintain its orientation relative to the water flow passively, for example the absorber may be arranged to weathervane relative to the water flow direction caused by waves. The passive orientation is preferably enabled by having a stable position of the centre of pressure or drag with respect to the rotational axis and the water flow direction.

The term “weathervane” will be understood by the skilled addressee as a common term in the art of renewable energy harnessing, and will be understood in the context of the present invention to mean change orientation or rotational position about a rotational axis thereof, under a directional force of water flow impinging thereon, to achieve or assume a stable equilibrium position (or angular alignment) relative to the rotational axis. This translation of rotational position or orientation will be understood to be distinct from the harnessing and generation of torque about the rotational axis.

Additionally, the absorber may preferably generate hydrodynamic lift as a result of its rotationally asymmetric shape, and may furthermore be of a hydrofoil shape so that the hydrodynamic lift is the primary outcome of the absorber's interaction with the water flow. When hydrodynamic lift constitutes a significant component of the hydrodynamic interaction between the absorber and the water flow direction then the rotation of the absorber is preferably able to optimise an angle of incidence, or angle of attack, of the absorber relative to the water flow direction. The angle of incidence/attack can be achieved actively with an actuator, or passively by having a relationship between the centre of lift, centre of drag and rotational axis that leads to an optimum and stable angle of attack for any given water flow direction.

An axi-asymmetric or foil-shaped absorber, when compared to an axisymmetric cylindrical or spherical absorber that generates the same hydrodynamic force, can be of a shape that does not contain or entrain such a large volume of water or air. As explained in the background to the invention, it is highly desirable to reduce the volume, mass, and/or buoyancy of the absorber in order to reduce the size, cost and complexity of the power converting machinery that is driven by the absorber. A non-foiled asymmetrical absorber can be of a membrane or plate type structure that contains little or no water or air and entrains a relatively small amount of water (this entrained water is sometimes referred to as added mass). A foiled absorber is evidently a substantially flatter, lower volume shape than a cylinder leading to a lower mass and buoyancy, and due to the hydrodynamic properties of a foil such as low drag, the added mass as a result of entrained water is also desirably small relative to a non-foil shaped absorber.

It should be noted that even though the absorber of the present invention is able to rotate, it is not a rotational absorber, specifically the mechanism of energy capture from the waves is not through creation and harnessing of a torque about the rotational axis. The mechanism of energy capture is through the translation of the rotational axis, preferably through an orbital path, to activate a drive assembly to convert the energy captured by the absorber into useful power (similar to the mechanism of energy capture in WECs that utilise an orbiting absorber disclosed in WO2013068748)

Therefore, in accordance with a first aspect of the present invention, there is provided a wave energy absorber comprising: one or more body portions arranged to engage hydrodynamically with a water flow from waves of a body of water, the one or more body portions each comprising a rotational axis about which the body portion is arranged to rotate, the body portion being asymmetrical in shape about the rotational axis.

The absorber of the present invention is preferably an absorber for in a WEC system. The one or more body portions may comprise a front end and a rear end extending diametrically away from the front end, wherein the rotational asymmetry of the one or more body portions may preferably be provided by the rotational axis being positioned closer to the front end than to the rear end. The one or more body portions preferably each comprises a flow engaging surface arranged to engage a flow of water impinging on the surface.

The shape of the one or more body portions is preferably such that, for any given direction of the water flow, the absorber will self-align, passively align or weathervane about the rotational axis to achieve or assume a stable equilibrium position (or angular alignment) relative to the rotational axis.

The absorber is preferably able to freely rotate about the rotational axis so that if the direction of the water flow changes, then the absorber (or the corresponding body portion thereof) is able passively re-align itself to an equilibrium position relative to the new water flow direction.

In an exemplary instance, wherein the water flow direction may frequently or constantly change, as it does during a wave cycle, then the absorber (or the corresponding body portion thereof) may frequently or constantly change its alignment, or rotational position about the rotational axis, accordingly. The alignment or rotational position may, for example, change through a 360-degree rotation with every wave, as the wave passes by, and engages, the absorber.

Other embodiments are possible, wherein the absorber or body portion thereof is rotated about the rotational axis by another active or passive means as described herein.

The rotational axis is preferably rotationally attached to a linkage arranged to couple the absorber to a wave energy converting device (WEC). The one or more body portions are preferably rotatable about the rotational axis relative to the linkage. The linkage preferably permits the rotational axis, and therefore the absorber, to move through a trajectory or pathway determined by the linkage. The linkage may, for example, comprise a first rigid or flexible lever arm arranged to reciprocate about a fulcrum along a rotation arc, the lever arm permitting the rotational axis to move through or along the arc. Alternatively, the linkage may be any suitable linkage arranged to permit translation or movement of the rotational axis, and therefore the absorber, in any direction.

The linkage may preferably comprise a second the lever arm having one end thereof rotationally attached to the fulcrum of the first lever arm thereby providing a pair of opposing bi-folding lever arms arranged to permit translation or movement of the rotational axis, and therefore the absorber, in any direction. Such a configuration preferably enables any cyclic or reciprocating working pathway or trajectory for the absorber in response to the waves. Most preferably the linkage enables an orbital pathway for the absorber, which has been found to best couple with the orbital energy flow of the waves and therefore provides optimum energy capture.

The linkage may, in some embodiments, actuate of one or more energy converters such that the wave energy captured by the absorber can be converted to useful energy. The one or more energy converters may be arranged to control the trajectory or pathway of the absorber, such as to optimise energy capture by the absorber, and preferably to optimise the pathway or trajectory in which the absorber moves. For example, the energy converter may control the pathway or trajectory of the absorber to avoid mechanical clashes with parts of an energy converter device structure, such as an offshore renewable energy system. The linkage may therefore form at least a portion of a drive assembly of the offshore renewable energy system.

In some embodiments, the linkage is preferably arranged to define a cyclic trajectory of the rotational axis. In embodiments, wherein the linkage is arranged to transfer energy from the absorber to a wave energy converter, the linkage may be arranged to drive a working stroke of the energy converter in a cyclic fashion, which may be by way of rotation of a rotor (for example of a rotational generator) or another suitable reciprocating movement. In such embodiments, the linkage may define a trajectory of movement of the absorber, the trajectory being cyclic or otherwise reciprocating in nature. In some embodiments, the cyclic trajectory is preferably an orbital trajectory.

In some embodiments, the one or more body portions preferably comprises a plurality of angles of rotation about the rotational axis, the angles of rotation defining a rotation arc of the body portion about the rotational axis.

In some embodiments, each of the plurality of angles of rotation preferably corresponds to a flow direction of the flow of water impinging on the flow engaging surface. The angles of rotation may therefore be assumed by the one or more body portions passively under the direction forces of the flow of water in the flow direction. The positioning of the rotational axis of the body portion, in a rotationally asymmetrical fashion thereby preferably permits the one or more body portions to passively assume an angle of rotation, of the plurality of angles of rotation, such that an optimum angle of attack is achieved relative to the flow direction, in a similar manner to that in which a kite holds its angle into a flow direction of the wind, depending on where the string is attached to the kite. In some embodiments, the body portion (which may be a portion of the body portion such as the flow engaging surface) is preferably shaped to assume a rotational position about the rotational axis according to a direction of the impinging flow of water. In such embodiments the one or more body portions preferably comprise a hydrofoil shape.

In some embodiments, the body portion preferably comprises a predefined array of the angles of rotation, each the angle of rotation in the array associated with a position of the rotational axis along the cyclic trajectory. In some embodiments, the device preferably further comprises an adjustment member arranged to urge a rotation of the body portion according to the angle of rotation, the angle of rotation selected from the predefined array. In such embodiments, the adjustment member may be arranged to urge the one or more body portions to assume a particular angle of rotation of the plurality of angles of rotation, according to a corresponding point along the cyclic trajectory.

Flow direction of water particles in a deep body of water such as a sea or an ocean, throughout a wave cycle of the water, typically moves through 360 degrees to draw an orbital trajectory throughout the wave cycle. The adjustment member may be arranged to adjust the angle of rotation of the one or more body portions about the rotational axis such that the flow engaging surface of the one or more body portions is oriented substantially opposing the flow direction, in order to capture maximum energy from the water flow throughout the 360 degrees movement of water particles during the wave cycle.

In such embodiments, the present invention is therefore preferably arranged to maximise capture of the available wave energy by utilising both vertical aspect of the wave profile and the directional forces available from water particle flow direction throughout the wave cycle. The capture may be performed as a result of passive rotation of the one or more body portions throughout the wave cycle, or by active rotation. In the context of the present invention, the term “passive” will be understood to mean without the input of electrical energy, which is contrastingly referred to herein as “active”.

In some embodiments, the rotation by the adjustment member is preferably arranged to be controlled by a controller. Embodiments will be appreciated, wherein the controller may be automatic and comprise a memory and a processor arranged to control the rotation according to data and/or instructions stored on the memory. The data may in some embodiments be used by the processor to train a model used to optimise the control of the rotation, for example based on a correlation between an amount of energy stored by a drive assembly and an angle of rotation of the body portion during a specific flow direction of the water.

In preferable embodiments, the controller may be arranged to receive power from a WEC system to perform the control of the rotation, the power being sourced at least in part from wave energy converted by the WEC system, the wave energy captured by the wave energy absorber. The wave energy absorber may therefore contribute energy toward the WEC system, wherein the energy may be used to power the controller of the device.

In some embodiments, the flow of water may preferably comprise: a first principal direction at a first time; and a second principal direction at a second time, each of the first and second principal directions being defined by a majority directional force applied to the flow engaging surface by the flow of water at the respective first and second time; wherein the body portion is arranged to rotate about the rotational axis between a first position in which the flow engaging surface of the body portion engages the flow of water in the first principal direction at the first time, and a second position in which the flow engaging surface engages the flow of water in the second principal direction at the second time

In some embodiments, the one or more body portions preferably comprises a body portion and an appendage extending therefrom and connecting the body portion to the rotational axis of the body portion. As such, the rotational axis of the one or more body portions of the present invention may be positioned at a distance from the one or more body portions defined by the appendage, wherein in all such embodiments, the rotational axis of the body portion is positioned relative to a longitudinal axis of the body portion closer to a front end of the body portion than a rear end of the body portion relative to corresponding points thereof along the longitudinal axis.

In preferable embodiments, the one or more body portions comprises a hydrofoil shape. The absorber in such preferable embodiments is therefore a hydrofoil, so that hydrodynamic interaction of the absorber with the wave-driven water flow preferably results in the creation of hydrodynamic lift. The hydrofoil may achieve an optimum angle of attack or incidence of the absorber to the water flow direction passively, for example by having the correct relationship between the rotational axis and a centre of lift of the absorber (hydrofoil). This passive self-alignment of the hydrofoil absorber is preferably similar to the manner in which a kite holds its angle into a flow direction of the wind, depending on where the string is attached to the kite. As previously discussed, the hydrofoil will preferably constantly/continuously self-align during the wave cycle resulting in the hydrofoil making a complete revolution as each wave passes by the wave energy converting device.

As previously described, a hydrofoil shaped absorber may also be aligned to the water flow direction actively with an actuator and controller.

In some embodiments, the one or more body portions of the absorber comprise: a first body portion; and a second body portion; each of the first and second body portions being rotatable about the rotational axis relative to one. In some preferable embodiments, the first and second body portions may be substantially planar, and may each therefore comprise a substantially flat sheet or plate.

In some embodiments comprising first and second body portions, the first and second body portions are preferably arranged to rotate about respective first and second loci, which may be on the rotational axis; wherein the first and second loci are collocated or proximate one another. Embodiments will be appreciated, wherein the first and second loci are not positioned on the rotational axis.

In some embodiments, the first and second body portions comprise a first and second longitudinal axis respectively. In such embodiments, the absorber preferably further comprises a rotational actuator arranged to rotate the first and second body portions between a first position in which the first and second longitudinal axes are non-parallel, and a second position in which the first and second longitudinal axes are substantially parallel. Such parallel alignment of the first and second body portions may, for example, be used to minimise forces acting on the respective body portions, which may be used in a storm survival configuration. In such embodiments, the first and second body portions may therefore be arranged to alternate between: a substantially planar orientation which may be arranged to weathervane with the water flow direction due to the waves, preferably offering little resistance to the water flow; and a substantially “v” shaped orientation, preferably offering greater resistance to the water flow.

In accordance with a second aspect of the present invention, there is provided a WEC system arranged to convert wave energy into useful energy, the system comprising: a buoyant platform; and a drive assembly mounted on the buoyant platform and arranged to capture and convert wave energy, the drive assembly comprising a wave energy absorber in accordance with the first aspect.

In some embodiments, the rotational axis of the body portion of the wave energy absorber is preferably positioned at a location relative to an upper surface of the buoyant platform. The drive assembly is preferably arranged to adjust the location along a cyclic trajectory. In preferable embodiments the cyclic trajectory is an orbital trajectory as described herein.

In some embodiments, the drive assembly may be arranged to adjust the location between an in-use height relative to the buoyant platform and a docked height relative to the buoyant platform, the in-use height being greater than the docked height. In some such embodiments, the in-use height is a height at which the wave energy absorber may capture wave energy, whereas at the docked height the wave energy absorber may not capture wave energy. Such a docked height may be used in some embodiments during a transport and maintenance configuration or during a storm survival configuration.

In preferable embodiments, the adjustment of the rotation by the controller, or the location by the drive assembly is independent of a working stroke of the drive assembly. Therefore, in such embodiments, the drive assembly may continue to function in capturing and converting wave energy to useful energy, while the rotation and/or location adjustment takes place, such that the rotation and/or location adjustment does not reduce the capacity of the drive assembly to function.

In preferable embodiments, the system comprises an in-use configuration in which the buoyant platform and the wave energy absorber of the drive assembly are submerged in a body of water, and preferably, wherein the wave energy absorber is positioned at an in-use height. At the in-use configuration, the one or more body portions of the wave energy absorber may be arranged to resist wave forces such that the body portion moves in the body of water along the cyclic (and preferably orbital) trajectory determined by wave forces acting thereon, thereby driving a working stroke of the drive assembly. In preferable embodiments, at locations along the orbital trajectory the rotation of the one or more body portions may be adjusted, whether passively by a water flow direction or by an adjustment member of the system, or actively by the controller, to maximise hydrodynamic forces acting on the one or more body portions in a desired direction. The forces may be used to drive the one or more body portions along the trajectory, and thereby contribute in driving the working stroke of the drive assembly.

Embodiments will be appreciated, wherein, during fluctuating sea states, the rotation of the one or more body portions may be dynamically adjusted by the controller according to the fluctuating sea states. For example, if a sea state during a first period constitutes a mild sea state, the rotation may be adjusted by the adjustment member in order to minimise the hydrodynamic nature of the one or more body portions in a water flow direction, such that maximal flow forces are permitted to act on a flow engaging surface of the one or more body portions, thereby maximising capture of the available energy during the mild sea state. If the sea state changes during a second period to a rougher, or stormy, sea state, the controller may adjust the rotation of the one or more body portions such that a reduced percentage of flow forces are permitted to act on the flow engaging surface of the one or more body portions. The reduced percentage of flow forces may comprise a sufficient flow force for the absorber to operate in capturing wave or flow energy, but not exceeding a safe wave or flow force threshold over which damage or excessive wear may be inflicted upon the absorber, or an energy conversion system affixed thereto.

In some preferable embodiments, the system comprises a storm configuration in which the buoyant platform and the wave energy absorber of the drive assembly are submerged in a body of water, and wherein the rotation of the one or more body portions is adjusted by the controller to minimise hydrodynamic forces acting on the one or more body portions.

In some embodiments, the system comprises an energy storage device arranged to receive and store energy converted by the drive assembly, and wherein the controller is arranged to receive and use the stored energy to perform the adjustment. The controller may therefore be powered by stored energy captured by the absorber, and may not require any other external power source.

It will be appreciated that features described herein as being suitable for incorporation into one or more aspects and embodiments of the present invention are intended to be generalizable across any and all aspect and embodiments of the present disclosure.

### BRIEF DESCRIPTION OF THE DRAWINGS

The accompanying drawings, which are incorporated in and constitute a part of the specification, illustrate embodiments of the invention and together with the detailed description herein, serve to explain the principles of the invention. The drawings are only for purposes of illustrating preferred embodiments and are not to be construed as limiting the invention. It is emphasized that, in accordance with the standard practice in the industry, various features are not drawn to scale. In fact, the dimensions of the various features may be arbitrarily increased or reduced for clarity of discussion. The foregoing and other objects, features and advantages of the invention are apparent from the following detailed description taken in conjunction with the accompanying drawings in which:

FIG. 1 shows a side view of an example WEC system in accordance with the second aspect comprising a wave energy absorber in accordance with the first aspect;

FIG. 2 shows an example cyclic (orbital) trajectory of the wave energy absorber of the embodiment of FIG. 1;

FIG. 3A shows a snapshot of a wave profile at a first point along the trajectory of FIG. 2, and both the wave propagation forces and water flow direction forces at the snapshot;

FIG. 3B shows a side view of a position of the system of FIG. 1 at the snapshot of FIG. 3A;

FIG. 4A shows a snapshot of a wave profile at a second point along the trajectory of FIG. 2, and both the wave propagation forces and water flow direction forces at the snapshot;

FIG. 4B shows a side view of a position of the system of FIG. 1 at the snapshot of FIG. 4A;

FIG. 5A shows a snapshot of a wave profile at a third point along the trajectory of FIG. 2, and both the wave propagation forces and water flow direction forces at the snapshot;

FIG. 5B shows a side view of a position of the system of FIG. 1 at the snapshot of FIG. 5A;

FIG. 6A shows a snapshot of a wave profile at a fourth point along the trajectory of FIG. 2, and both the wave propagation forces and water flow direction forces at the snapshot;

FIG. 6B shows a side view of a position of the system of FIG. 1 at the snapshot of FIG. 6A;

FIG. 7 shows a side view of an alternate example WEC system in accordance with the second aspect comprising a wave energy absorber in accordance with the first aspect; and

FIG. 8 shows a side view of a position of the system of FIG. 7 at a snapshot of a wave profile along a trajectory similar to that shown in FIG. 2.

### DETAILED DESCRIPTION FOR CARRYING OUT THE INVENTION

All of the presently described embodiments comprise a wave energy absorber in accordance with the first aspect as part of a WEC system in accordance with the second aspect. The embodiments each have substantially the same general structure which is summarised briefly here. The system comprises a cylindrical buoyant platform supporting a drive assembly on an upper surface thereof. The drive assembly comprises a first lower pair of opposing elongate rigid lever arms coupled at one end at a lower hinge positioned centrally on the upper surface of the platform. The other end of each lever arm of the first lower pair is rotably affixed to one end of a corresponding rigid lever arm of a second upper pair of lever arms. The second upper pair of lever arms are coupled at an upper hinge. The drive assembly further comprises a wave energy absorber in accordance with the first aspect, affixed to the upper hinge. Each lever arm of the first lower pair of lever arms is affixed to an energy converter, which for illustrative purposes takes the form of hydraulic ram, but may comprise any suitable energy converter such as a rotational generator.

In use, the platform and the wave energy absorber are submerged in a body of water using a mooring and anchoring system (not shown). In the in-use configuration, the wave energy absorber is arranged to move following a substantially orbital trajectory as a result of wave forces impacting thereon. As the wave energy absorber moves, the consequential movement of the lever arms drives the corresponding energy converters.

The extent of the ability of the wave energy absorber to capture wave energy is generally proportional to the availability of wave forces acting on the device. For a wave energy absorber, the wave forces include a vertical component according to the crest and trough periods of a wave cycle, and a horizontal component according to the wave propagation direction. For a wave energy absorber which is designed to be submerged in-use, the wave forces also include an additional directional component corresponding to a direction of water particle flow occurring beneath the surface of the waves, which typically tracks an orbital trajectory throughout a wave cycle. In order to maximise capture of the wave energy available, the present invention aims to make optimum use of all the components of the directional forces available.

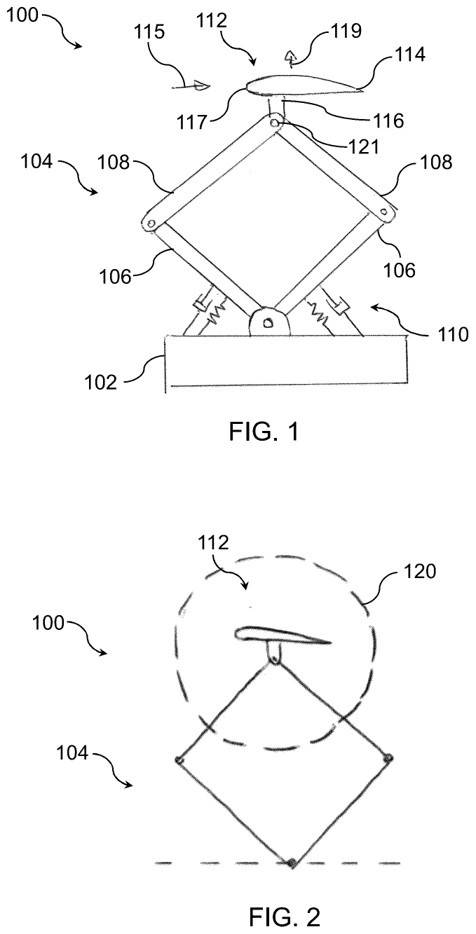

Referring to FIG. 1 and FIG. 2, a first embodiment 100 of the present invention is shown, and functions substantially as previously described. The embodiment 100 comprises a WEC system 100 in accordance with the second aspect comprising a buoyant platform 102 supporting a drive assembly 104 mounted on an upper surface thereof. The drive assembly 104 comprises a first lower pair of rigid lever arms 106 and a second upper pair of rigid lever arms 108 as previously described. The drive assembly 104 comprises energy converters 110 affixed to the lower pair of lever arms 106. Coupled to the second pair of lever arms 108, the drive assembly 104 further comprises a wave energy absorber 112. In the embodiment 100 shown, the absorber 112 comprises a single hydrofoil body portion having a positively body 114 and an elongate metal appendage 116 extending from a position thereof closer to a leading edge 117 of the hydrofoil body 114. The absorber 112 further comprises an adjustment mechanism (not shown) which comprises a motor arranged to be driven electrically according to a controller. In an in-use configuration as shown in FIG. 1, the motor of the adjustment mechanism is arranged to drive a rotation of the body portion 114, 116 about a rotational axis 121 thereof. In the in-use configuration shown, the rotational position of the hydrofoil body 114 provides an optimal angle of attack relative to a water flow direction 115 of water impinging on the leading edge thereof, such that the body 114 maximises hydrodynamic lift 119 causing the body 114 to drive the rotational axis thereof in an upward motion, extending the lever arms 106, 108 of the drive assembly 104 to drive the energy converters 110.

The angle of attack would be expected to reach a steady equilibrium during the unidirectional flow 115 shown, however as the water flow is generated by waves, the direction of the subsurface water flow is constantly changing in a circular or orbital pattern. Therefore, the body 114 is able to rotate about the rotational axis 121, maintaining a consistent angle of attack with the water flow.

The hydrofoil body 114 generates a lift force which pulls the rotational axis 121 in the same direction; as the direction of the lift force is changing in circular cycle caused by the waves (and the corresponding subsurface flow), the rotational axis 121 is caused to move in an orbital path 121 as shown FIG. 2. This orbital motion is exploited by the drive assembly 104 to generate power.

Referring to FIG. 2, an overall expected orbital trajectory 120 of the rotational axis 121 of the body portion 114, 116 is shown, along which the rotational axis 121 will travel throughout a wave cycle of the body of water in which the system 100 is submerged.

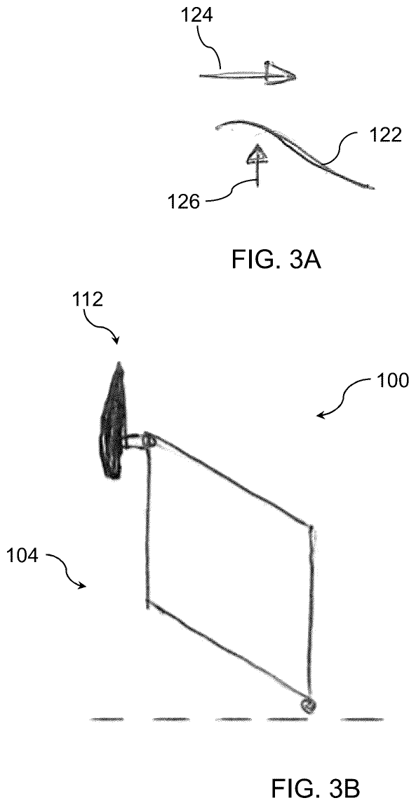

The embodiment 100 is shown in use in FIG. 3A to FIG. 6B. FIGS. 3A, 4A, 5A and 6A pictorially represent a snapshot of a wave profile of a body of water in which the embodiment 100 is submerged, at a specific point during a wave cycle. Throughout FIGS. 3A, 4A, 5A and 6A, the wave profile 122 is propagated 124 continuously in a principal horizontal direction, while the subsurface water particle flow direction 126 changes throughout the wave cycle following a circular, or orbital, pattern. FIGS. 3B, 4B, 5B, and 6B each show a corresponding position of the embodiment 100 at the snapshot, and when presented by wave forces acting at the snapshot and throughout the wave cycle.

Referring to FIG. 3A, the wave profile 122 is such that subsurface water particle flow forces 126 act in a principally vertical upward direction, such that the hydrofoil body 114 in FIG. 3B of the absorber 112 is oriented with the flow engaging surface of the leading edge 117 positioned opposing the principal directional forces 126 such that hydrodynamic lift is provided in a left direction (relative to the depiction shown) driving the rotational axis 121 of the absorber 112 along the orbital trajectory 120 to the left. Such movement of the absorber 112 causes a corresponding movement of the drive assembly 104 and a consequential driving of a portion of a working stroke of the corresponding energy converters 110 relative to the extent of the movement.

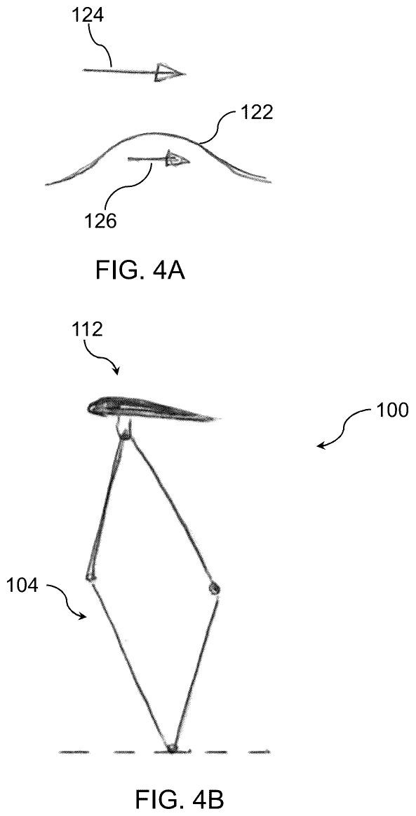

Referring to FIG. 4A, the wave profile 122 is such that subsurface water particle flow forces 126 act in a principally horizontal right direction, such that the hydrofoil body 114 in FIG. 4B of the absorber 112 is oriented with the flow engaging surface of the leading edge 117 positioned opposing the principal directional forces 126 such that hydrodynamic lift is provided in a upwards direction (relative to the depiction shown) driving the rotational axis 121 of the absorber 112 along the orbital trajectory 120 upwards, and thus completing a half-cycle of the orbital trajectory 120 of the rotational axis 121. Such movement of the absorber 112 causes a corresponding movement of the drive assembly 104 and a consequential driving of a portion of a working stroke of the corresponding energy converters 110 relative to the extent of the movement.

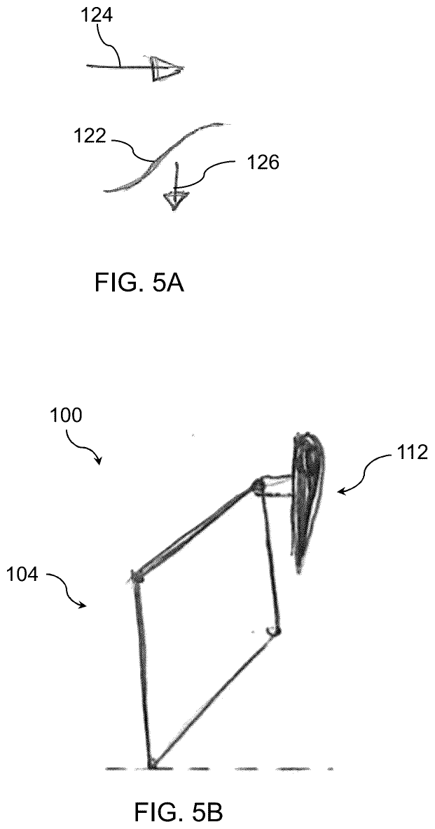

Referring to FIG. 5A, the wave profile 122 is such that subsurface water particle flow forces 126 act in a principally vertical downward direction, such that the hydrofoil body 114 in FIG. 5B of the absorber 112 is oriented with the flow engaging surface of the leading edge 117 positioned opposing the principal directional forces 126 such that hydrodynamic lift is provided in a right direction (relative to the depiction shown) driving the rotational axis 121 of the absorber 112 along the orbital trajectory 120 to the right. Such movement of the absorber 112 causes a corresponding movement of the drive assembly 104 and a consequential driving of a portion of a working stroke of the corresponding energy converters 110 relative to the extent of the movement.

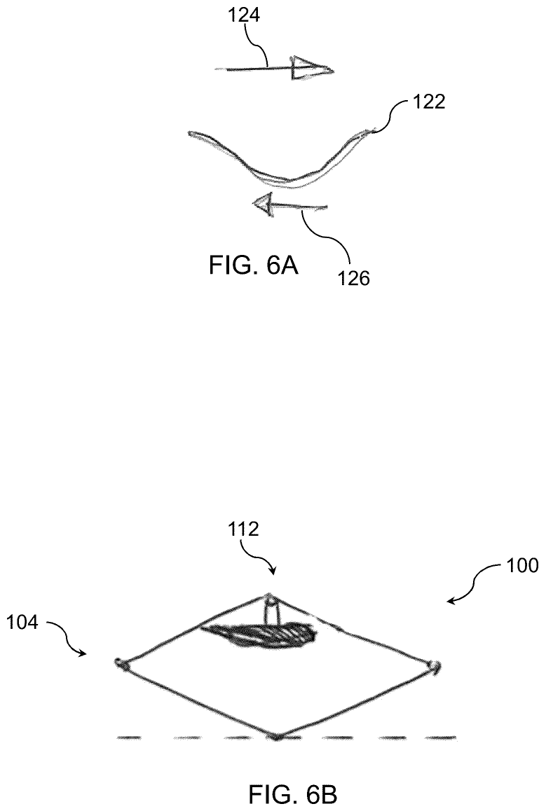

Referring to FIG. 6A, the wave profile 122 is such that subsurface water particle flow forces 126 act in a principally horizontal left direction, such that the hydrofoil body 114 in FIG. 6B of the absorber 112 is oriented with the flow engaging surface of the leading edge 117 positioned opposing the principal directional forces 126 such that hydrodynamic lift is provided in a downwards direction (relative to the depiction shown) driving the rotational axis 121 of the absorber 112 along the orbital trajectory 120 downwards, and thus completing a cycle of the orbital movement 120 of the rotational axis 121. Such movement of the absorber 112 causes a corresponding movement of the drive assembly 104 and a consequential driving of a portion of a working stroke of the corresponding energy converters 110 relative to the extent of the movement.

In describing the movement of the absorber 112 in the present embodiments, the terms left, right, upwards and downwards are used. These terms will be understood in the context of the exemplary two-dimensional depictions shown in the present figures, and it will be appreciated that such terms may refer in practice to a more complex movement in any relative direction corresponding to a three-dimensional absorber in-use.

The embodiment 100 shown has a body 114 which is rotated by a controller (not shown) actuating a motor. The controller is arranged to rotate the body 114 by the motor based on a corresponding position of the rotational axis 121 along the orbital path 120. Thereby, the controller is arranged to optimise driving of the working stroke by maximising hydrodynamic lift in a required direction. Other embodiments may include a flow direction sensor which may inform the controller of a water flow direction, such that a corresponding adjustment of the rotation may be performed in order to optimise the hydrodynamic lift in a desired direction. Additionally, embodiments may be envisaged comprising a sea state monitor or a wave force sensor arranged to detect excessive sea forces which may lead to damage to the drive assembly through excessive or chaotic movement of the absorber 112. In such embodiments, dynamic adjustment of the rotation may be performed in order to provide sufficient hydrodynamic lift to drive the working stroke, while operating within a safe window of hydrodynamic lift such that excessive wave forces are not exposed to the absorber 112. Such an embodiment may be advantageous for providing a storm survival configuration.

In the example 100 shown, the body 114 or the body portion 112 is distanced from the rotational axis 121 by the appendage 116. Embodiments will be appreciated, wherein the rotational axis is positioned on the body itself.

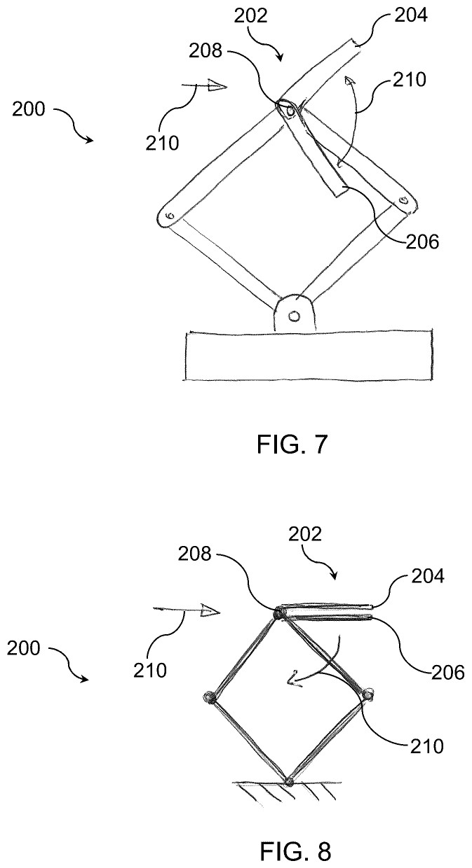

A second embodiment 200 of the invention is show in FIG. 7 and FIG. 8. The second embodiment 200 comprises a WEC system substantially as shown in FIG. 1 to FIG. 6B, but having a wave energy absorber 202 having a first body portion 204 and a second body portion 206, each formed of an elongate bar affixed to a common rotational axis 208 at a first end thereof. The first and second body portions 204, 206 are arranged to be rotated about the rotational axis 208 by a controller driving a motor (not shown) in the same manner as that described in the embodiment 100 of FIG. 1. The controller is arranged to drive the rotation 210 of the body portions 204, 206 independently of one another such that a custom flow engaging surface may be formed of the body portion 204, 206 as required, thereby providing an embodiment with dynamic hydrodynamics and lift adjustment capabilities as required.

In the configuration shown in FIG. 7, the body portions 204, 206 for an asymmetrical ‘v’-shaped absorber 202. The common rotational axis 208 at the point of the ‘v’ shape means that the absorber 202 will naturally tend to align into the water flow direction 212 with the point of the ‘v’ facing the flow direction.

As the direction of the water flow 212 changes with the wave cycle as described herein, the absorber 202 will continuously align itself to the water flow direction 212, which in a wave cycle will follow a circular path dictated by the waves.

The water flow over the absorber 202 will cause a pressure force on the flow engaging surface of the absorber 202 pointing into the water flow direction 212 and this pressure force will cause the absorber 202 to rotate about the rotational axis 208 corresponding to the flow direction 212. The circular path direction of the resultant force from the absorber 202 will cause the rotational axis 208 to move in an orbital motion, and this orbital motion will be exploited by the drive assembly affixed thereto to generate power in the same manner as described for the embodiment 100 of FIG. 1.

The angle of the ‘v’ can be adjusted by the controller to adjust the pressure force on the absorber 202 and therefore the amount of energy absorbed from the waves. This can be used to both optimise energy capture in small waves and limit forces impinging on the absorber 202 during large waves.

With reference to FIG. 8, the body portions 204, 206 can be caused by the controller to converge such that the longitudinal axes thereof are substantially parallel. Such a configuration may be used to dramatically reduce wave forces impinging on the absorber 202 during storms. This can, in some embodiments, be further combined with a retraction of the absorber 202 further underwater, more proximate the platform, using the drive assembly.

Further embodiments within the scope of the present invention may be envisaged that have not been described above, for example, the buoyant platform is illustrated as a fixed block in all of the described embodiments for illustration purposes only, but embodiments will be appreciated, wherein the platform is any suitable structure arranged to remain relatively stationary in the body of water relative to the energy absorber. For example, the platform may comprise a buoyant underwater platform that is moored to the seabed; or any buoyant/non-buoyant structure that directly affixes to the seabed.

The energy converter in all described embodiments, for illustrative purposes only, is shown to be a simplified hydraulic cylinder combined with a separate spring unit. Embodiments will be appreciated, wherein in any suitable form of energy converter may be used, for example: a linear electrical generator; a rotational electrical or hydraulic generator; or any kind of rotational generator which may be combined with a mechanism that converts rotational motion to linear motion such as a rack and pinion.

The adjustment members described take the form of a motor driving rotation. Any suitable adjustment mechanism, including any suitable mechanical mechanism, will be appreciated, such as any hydraulic mechanism, a rack and pinion gear or a ratchet and pawl mechanism.

The body portions of the described embodiments take the form of a hydrofoil or an elongate bar shape, but embodiments will be appreciated, wherein any shape of body portion may be used.

The invention is not limited to the specific examples or structures illustrated and will be understood to be any embodiment falling within the scope of the appended claims.

What is claimed is:

1. A wave energy absorber, the absorber comprising:
one or more body portions arranged to engage hydrodynamically with a water flow from waves of a body of water, the one or more body portions each comprising a rotational axis about which the body portion is arranged to rotate, the body portion being asymmetrical about the rotational axis.

2. The wave energy absorber of claim 1, wherein the absorber further comprises:
a linkage arranged to couple the one or more body portions to a wave energy converter (WEC), the one or more body portions being rotatable about the rotational axis relative to the linkage.

3. The wave energy absorber of claim 2, wherein the linkage is arranged to define a cyclic trajectory of the rotational axis.

4. The wave energy absorber of claim 3, wherein the cyclic trajectory is an orbital trajectory.

5. The wave energy absorber of claim 3, wherein the one or more body portions comprises a plurality of angles of rotation about the rotational axis, the angles of rotation defining a rotation arc of the one or more body portions about the rotational axis.

6. The wave energy absorber of claim 5, wherein each of the plurality of angles of rotation corresponds to a flow direction of the flow of water impinging on a flow engaging surface of the one or more body portions.

7. The wave energy absorber of claim 6, wherein the one or more body portions are shaped to assume a rotational position about the rotational axis according to a direction of the impinging flow of water.

8. The wave energy absorber of claim 5, wherein the one or more body portion comprises a predefined array of the angles of rotation, each angle of rotation in the array is associated with a position of the rotational axis along the cyclic trajectory.

9. The wave energy absorber of claim 8, wherein the absorber further comprises an adjustment member arranged to urge a rotation of the one or more body portions according to the angle of rotation, the angle of rotation selected from the predefined array.

10. The wave energy absorber of claim 9, wherein the rotation by the adjustment member is arranged to be controlled by a controller.

11. The wave energy absorber of claim 1, wherein the one or more body portions comprises a hydrofoil shape.

12. The wave energy absorber of claim 1, wherein the one or more body portions of the absorber comprise:
a first body portion having a first longitudinal axis; and
a second body portion having a second longitudinal axis;
each of the first and second body portions being rotatable about the rotational axis relative to one another.

13. The wave energy absorber of claim 12, wherein the first and second body portions are arranged to rotate about respective first and second loci on the rotational axis;
wherein the first and second loci are collocated or proximate one another.

14. The wave energy absorber of claim 12, wherein the absorber further comprises a rotational actuator arranged to rotate the first and second body portions between a first position in which the first and second longitudinal axes are non-parallel, and a second position in which the first and second longitudinal axes are substantially parallel.

15. A wave energy converter system arranged to convert wave energy into useful energy, the system comprising:
a buoyant platform; and
a drive assembly mounted on the buoyant platform and arranged to capture and convert wave energy, the drive assembly comprising a wave energy absorber as claimed in any one of the preceding claims.

16. The system of claim 15, wherein the rotational axis of the one or more body portions of the wave energy absorber is positioned at a location relative to an upper surface of the buoyant platform.

17. The system of claim 16, wherein the drive assembly is arranged to adjust the location along a cyclic trajectory.

18. The system of claim 17, wherein the cyclic trajectory is an orbital trajectory.

19. The system of claim 17, wherein the adjustment of the location by the drive assembly is independent of a working stroke of the drive assembly.
